(19) United States
(12) Patent Application Publication
(10) Pub. No.: US 2012/0036028 A1
(43) Pub. Date: Feb. 9, 2012

(54) METHOD OF AND SYSTEM FOR GROUP MEAL ORDERING VIA MOBILE DEVICES

(76) Inventor: Christopher James Webb, Los Angeles, CA (US)

(21) Appl. No.: 13/192,591

(22) Filed: Jul. 28, 2011

Related U.S. Application Data
(60) Provisional application No. 61/370,519, filed on Aug. 4, 2010.

(51) Int. Cl. G06Q 50/12

(52) U.S. Cl. 705/15

(57) ABSTRACT

A ordering food method using mobile devices includes initiating, by an organizer, a food ordering application on at least one mobile device of a plurality of mobile devices, selecting, by the organizer, a restaurant for ordering the food and creating, by the organizer, a single group meal order by inviting a plurality of individuals to order food from the selected restaurant. The method further includes accepting, by the plurality of individuals, the invitation, reviewing, by the organizer and the plurality of individuals on the plurality of mobile devices, a menu of the selected restaurant and selecting a plurality of food items from the menu. The method further includes combining, by the food ordering application, the plurality of selected food items into the single group meal order and forwarding, by the food ordering application, the single group meal order to the selected restaurant.

### CROSS-REFERENCE TO RELATED APPLICATIONS

This patent application claims priority from, and incorporates by reference the entire disclosure of, U.S. Provisional Patent Application No. 61/370,519, filed Aug. 4, 2010.

### BACKGROUND

1. Technical Field

The present invention relates to a method of and system for ordering meals from restaurants, and, more particularly, but not by way of limitation, to a method of and system for accessing information concerning food and then ordering meals from restaurants as a group via mobile devices.

2. History of Related Art

Ordering take-out or delivery food has been a common occurrence for most households within the United States for many years. The process of ordering take-out or delivery, however, has not changed that much. Systems are in place that allow restaurants the convenience of receiving orders from customers without wasting time on the phone taking orders. The restaurants may receive orders from customers via, for example, an SMS message. Such systems eliminate long lines during the restaurant's peak business hours and increase restaurant sales by decreasing time spent by restaurant employees for fulfillment of orders. In turn, users are able to order on-the-go and save time by not having to spend time waiting to order at the restaurant.

### SUMMARY OF THE INVENTION

A method of ordering food using mobile devices. The method includes initiating, by an organizer, a food ordering application on at least one mobile device of a plurality of mobile devices, selecting, by the organizer, a restaurant for ordering the food and creating, by the organizer, a single group meal order by inviting a plurality of individuals to order food from the selected restaurant. The method further includes accepting, by the plurality of individuals, the invitation, reviewing, by the organizer and the plurality of individuals on the plurality of mobile devices, a menu of the selected restaurant and selecting, by the organizer and the plurality of individuals, a plurality of food items from the menu. In addition, the method includes combining, by the food ordering application, the plurality of selected food items into the single group meal order and forwarding, by the food ordering application, the single group meal order to the selected restaurant.

A computer-program product comprising a computer-usable medium having computer-readable program code embodied therein, the computer-readable program code adapted to be executed to implement a method of ordering food using mobile devices. The method includes initiating, by an organizer, a food ordering application on at least one mobile device of a plurality of mobile devices, selecting, by the organizer, a restaurant for ordering the food and creating, by the organizer, a single group meal order by inviting a plurality of individuals to order food from the selected restaurant. The method further includes accepting, by the plurality of individuals, the invitation, reviewing, by the organizer and the plurality of individuals on the plurality of mobile devices, a menu of the selected restaurant and selecting, by the organizer and the plurality of individuals, a plurality of food items from the menu. In addition, the method includes combining, by the food ordering application, the plurality of selected food items into the single group meal order and forwarding, by the food ordering application, the single group meal order to the selected restaurant.

A system for ordering food. The system includes a plurality of mobile devices that operate a food ordering application and a plurality of servers coupled to the plurality of mobile devices via a network. An organizer initiates the food ordering application on at least one of the plurality of mobile devices, selects a restaurant for ordering the food, and creates a single group meal order by inviting a plurality of individuals to order food from the selected restaurant and that the plurality of individuals accept the invitation using the plurality of mobile devices. The organizer and the plurality of individuals select a plurality of food items from a menu displayed on the plurality of mobile devices. The food ordering application combines the plurality of selected food items into the single group meal order and forwards the single group meal order to the selected restaurant.

### BRIEF DESCRIPTION OF THE DRAWINGS

A more complete understanding of the method and system of the present invention may be obtained by reference to the following Detailed Description when taken in conjunction with the accompanying Drawings wherein:

FIG. 1 is a block diagram illustrating a system capable of implementing exemplary embodiments of the present invention;

FIG. 2 is a flow diagram illustrating a process for ordering food as a group according to exemplary embodiments;

FIG. 3 is a block diagram illustrating a process for payment processing according to exemplary embodiments;

FIGS. 4A-4M illustrate screen shots of a process for ordering food as a group utilizing an exemplary food ordering application according to exemplary embodiments; and

FIGS. 5A-5B illustrate screen shots of the exemplary food ordering application utilizing social networking sites according to exemplary embodiments.

### DESCRIPTION OF THE EXEMPLARY EMBODIMENTS

Embodiment(s) of the invention will now be described more fully with reference to the accompanying Drawings. The invention may, however, be embodied in many different forms and should not be construed as limited to the embodiment(s) set forth herein. The invention should only be considered limited by the claims as they now exist and the equivalents thereof.

In today's fast paced environment, there is no way to order meals as a group via mobile devices. Presently, in order for a group of individuals to place a meal order as a group, it is required that each individual from the group communicate with a restaurant either manually, in-person, or via voice communications. This is often very time consuming and cumbersome. Embodiments of the present invention provide a system and method for ordering meals as a group using, for example, mobile devices.

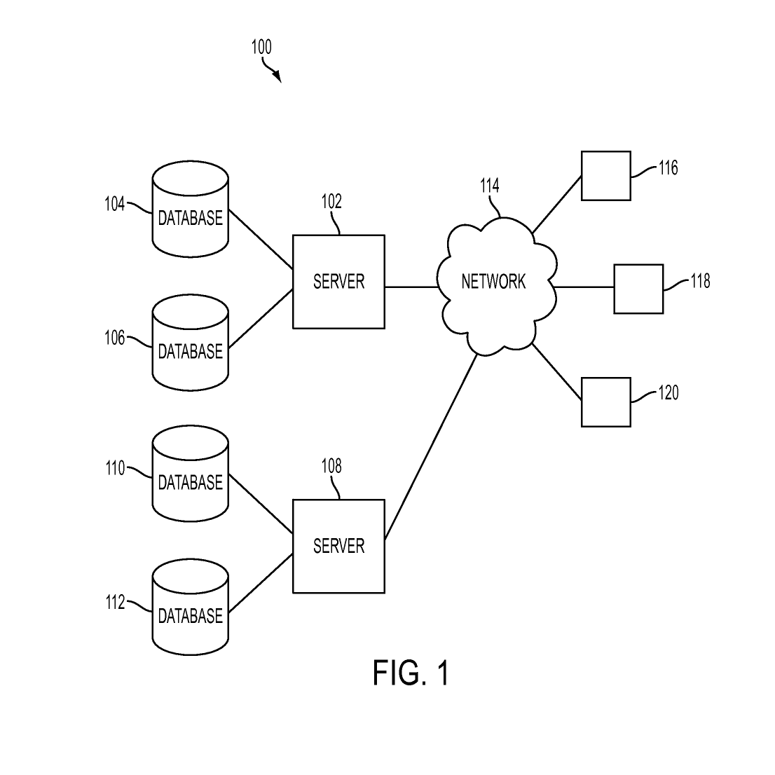

FIG. 1 is a block diagram illustrating a system capable of implementing exemplary embodiments of the present invention. The system 100 includes a plurality of servers 102, 108 connected to a plurality of databases 104, 106, 110, 112. In a typical embodiment, the plurality of servers 102, 108 may be, for example, server computers, personal computers (PCs), mainframe computers, or the like. Communication between the plurality of servers 102, 108 may take place using, for example, HTTP, TCP/IP, or XML. In alternate embodiment, communication between the plurality of servers 102, 108 may take place using connection-oriented or connectionless communication protocols such as, for example, HTTP, TCP/IP, or FTP. In various embodiments, the plurality of databases 104, 106, 110, 112 may be implemented using, for example, Oracle™ databases, MS Access™ databases, MS SQL, IBM DB2, and the like.

The plurality of servers 102, 108 are also connected via a network 114 to a plurality of mobile devices 116, 118, 120. In a typical embodiment, the plurality of mobile devices 116, 118, 120 may be, for example, personal digital assistants (PDA), Internet and multimedia-enabled Smartphones, tablet computers, portable media players, portable computers, and the like. In a typical embodiment, the network 114 may be, for example, a wireless data network which may include, for example, cellular networks, Wi-Fi networks, WiMAX networks, and the like. The plurality of databases 104, 106, 110, 112 are operable to store a plurality of data items. For example, the plurality of data items may be, for example, menus for a plurality of restaurants. The plurality of servers 102, 108 are operable to access the plurality of data items and forward the plurality of data items to the plurality of mobile devices 116, 118, 120.

In a typical embodiment, the plurality of mobile devices 116, 118, 120 are capable of downloading third-party applications. For example, the third-party applications are computer software applications designed to help users perform singular or multiple related specific tasks. Once downloaded, the third-party applications appear around a home screen of the plurality of mobile devices 116, 118, 120. In a typical embodiment, an exemplary food ordering application may be downloaded by users of the plurality of mobile devices 116, 118, 120 via a digital application distribution platform. The exemplary food ordering application facilitates, for example, a purchase transaction between the plurality of mobile devices 116, 118, 120 and a plurality of vendors. In a typical embodiment, the plurality of vendors may be, for example, a plurality of restaurants.

The plurality of mobile devices 116, 118, 120 are operable to interact with the plurality of servers 102, 108 to request the plurality of data items stored in the plurality of databases 104, 106, 110, 112. The exemplary food ordering application operating on the plurality of mobile devices 116, 118, 120 communicates with the plurality of servers 102, 108 to perform a plurality of tasks such as, for example, food ordering. In a typical embodiment, the exemplary food ordering application comprises a group food ordering feature that allows a plurality of individuals such as, for example, friends and co-workers to place food orders together from different locations. The exemplary food ordering application further provides an ability to pay separately despite the restaurant receiving the food order as one single consolidated order.

According to alternate embodiments, the exemplary food ordering application may be, for example, a third-party application for social networking sites such as, for example, Facebook®. For example, the exemplary food ordering application comprises a group food ordering feature that allows a plurality of individuals such as, for example, friends and co-workers to place food orders together from different locations utilizing social networking sites such as, for example, Facebook®. The exemplary food ordering application further provides an ability to pay separately despite the restaurant receiving the food order as one single consolidated order.

According to an exemplary embodiment, if an organizer of a study group decides to order food for other individuals in the study group, then instead of guessing what other individuals in the study group want, the organizer initiates a food order. For example, the organizer may initiate the food order via, for example, the exemplary food ordering application using at least one of the plurality of mobile devices 116, 118, 120 by choosing a restaurant and delivery time. Next, the organizer invites all other individuals in the study group who receive a notification on their mobile devices 116, 118, 120 with a message. The message may be, for example, “John has invited you to join his food order at ABC restaurant”. In a typical embodiment, the exemplary system 100 is set up using the plurality of servers 102, 108 and push notifications enabling the plurality of mobile devices 116, 118, 120 to communicate with each other, relaying food orders back and forth and handling payment options. After accepting the invitation, the individuals from the study group pull up a menu of the ABC restaurant on the plurality of mobile devices 116, 118, 120. According to exemplary embodiments, the plurality of databases 104, 106, 110, 112 are operable to store a plurality of data items. For example, the plurality of data items may be, for example, menus for a plurality of restaurants. The plurality of servers 102, 108 are operable to access the plurality of data items and forward the plurality of data items to the plurality of mobile devices 116, 118, 120. After reviewing the menu on the mobile devices 116, 118, 120, the individuals choose food items of their choice and send their order back to the organizer The selection is then automatically combined with other members of the group by the exemplary food ordering application and sent by, for example, the organizer via the exemplary food ordering application to the restaurant as a single consolidated order. In a typical embodiment, each individual from the study group is billed separately. According to alternate embodiments, the payments may be made to the restaurant by the organizer.

While the system 100 described in FIG. 1 is capable of executing the invention described herein, the system 100 is simply one example of a system that may be used to implement various embodiments of the invention. Those skilled in the art will appreciate that, although only four databases 104, 106, 110, 112, two server 102, 108, and three mobile devices 116, 118, 120 are illustrated as part of the system 100, a varying number of each may be employed in a system implementing various embodiments of the invention without departing from principles of the invention.

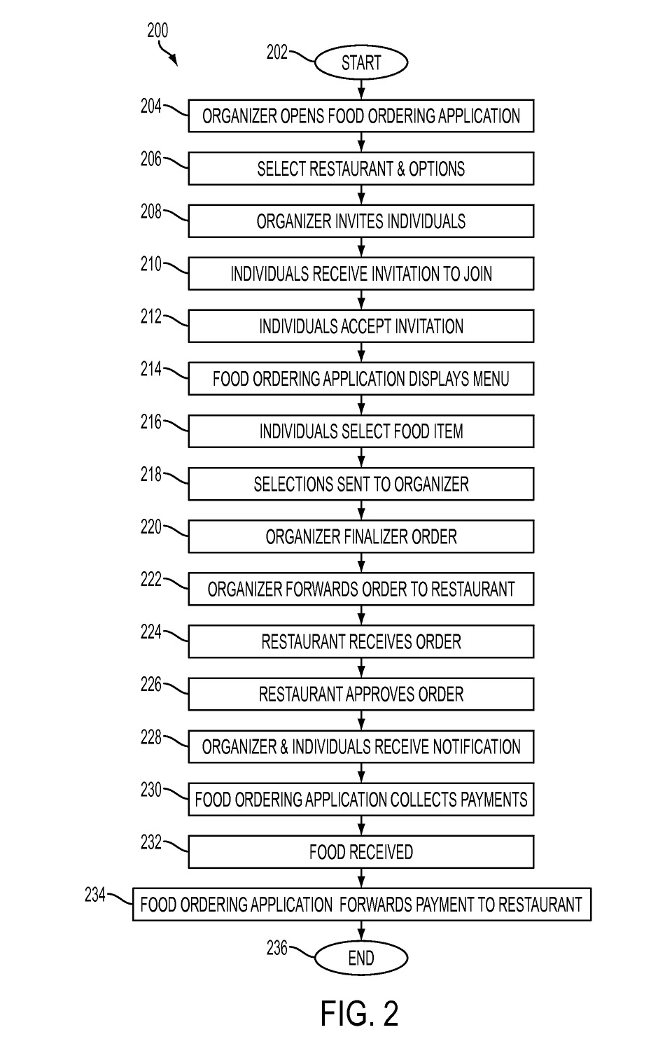

Referring now to FIG. 2, a block diagram illustrating a process 200 for ordering food as a group is discussed according to an exemplary embodiment. According to exemplary embodiments, the process 200 may be implemented utilizing the exemplary food ordering application operating on the plurality of mobile devices 116, 118, 120. According to alternate embodiments, the exemplary food ordering application may be, for example, a third-party application for social networking sites such as, for example, Facebook®. The process 200 starts at step 202. At step 204, an organizer of, for example a study group opens the exemplary food ordering application on at least one of the plurality of mobile devices 116, 118, 120. In a typical embodiment, the plurality of mobile devices 116, 118, 120 may be, for example, personal digital assistants (PDA), Internet and multimedia-enabled Smartphones, tablet computers, portable media players, portable computers, and the like. At step 206, the organizer chooses a restaurant for ordering food and an option for either food delivery or food pick-up. At step 208, the organizer invites other individuals in, for example, the study group to join a meal order. For example, the invitations may be extended to other individuals by entering their E-mail addresses. In alternate embodiments, the invitations may be extended to other individuals via social networking sites such as, for example, Facebook®. At step 210, each individual receives a notification on their mobile devices 116, 118, 120 with a message to join the organizers meal order. At step 212, individuals accept the invitation to join the meal order. At step 214, the exemplary food ordering application displays a menu of the selected restaurants on the mobile devices 116, 118, 120 of the individuals who accepted the invitation. According to exemplary embodiments, the plurality of databases 104, 106, 110, 112 are operable to store a plurality of data items. For example, the plurality of data items may be, for example, menus for a plurality of restaurants. The plurality of servers 102, 108 are operable to access the plurality of data items and forward the plurality of data items to the plurality of mobile devices 116, 118, 120. According to exemplary embodiment, an individual that neither accepts or declines the invitation, is dropped from the meal order.

At step 216, each individual selects items from the menu. In a typical embodiment, the items may be, for example, food, drinks, or any other product available at the restaurant. At step 218, selections made by each individuals is forwarded to the mobile device 116, 118, 120 of the organizer At step 220, the organizer finalizes the order and forwards the order as one single consolidated order to the restaurant (step 222). At step 224, the restaurant receives the single consolidated order from the organizer and approves the order (Step 226). At step 228, the organizer and individuals receive notifications on their mobile devices. At step 230, the application collects payments from each individual separately. At step 232, the food is received and a single payment is sent using the exemplary food ordering application to the restaurant for the single consolidated order (step 234). At step 236, the process 200 ends.

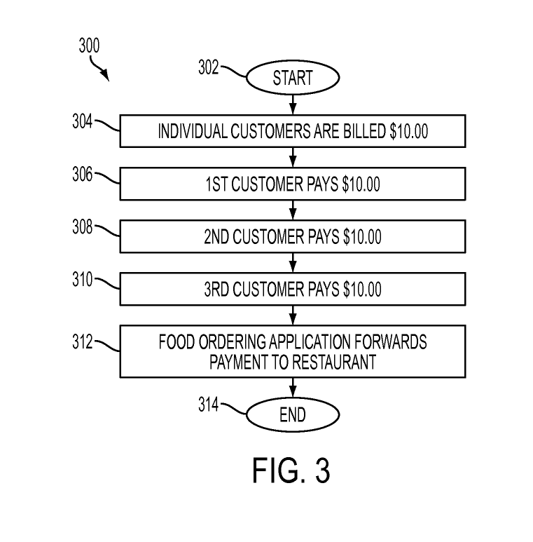

Referring now to FIG. 3, a block diagram illustrating a process 300 for payment processing is discussed according to an exemplary embodiment. The process 300 starts at step 302. At step 304, each individual from the group is billed $10 for the items ordered from the restaurant. For exemplary purposes, it is assumed that each individual ordered items from the restaurant totaling $10. At step 306, a first individual electronically forwards $10 to the application. At step 308, a second individual electronically forwards $10 to the application. At step 310, a third individual electronically forwards $10 to the application. At step 312, the exemplary food ordering application forwards a single payment to the restaurant for the single consolidated order. At step 314, the process 300 ends.

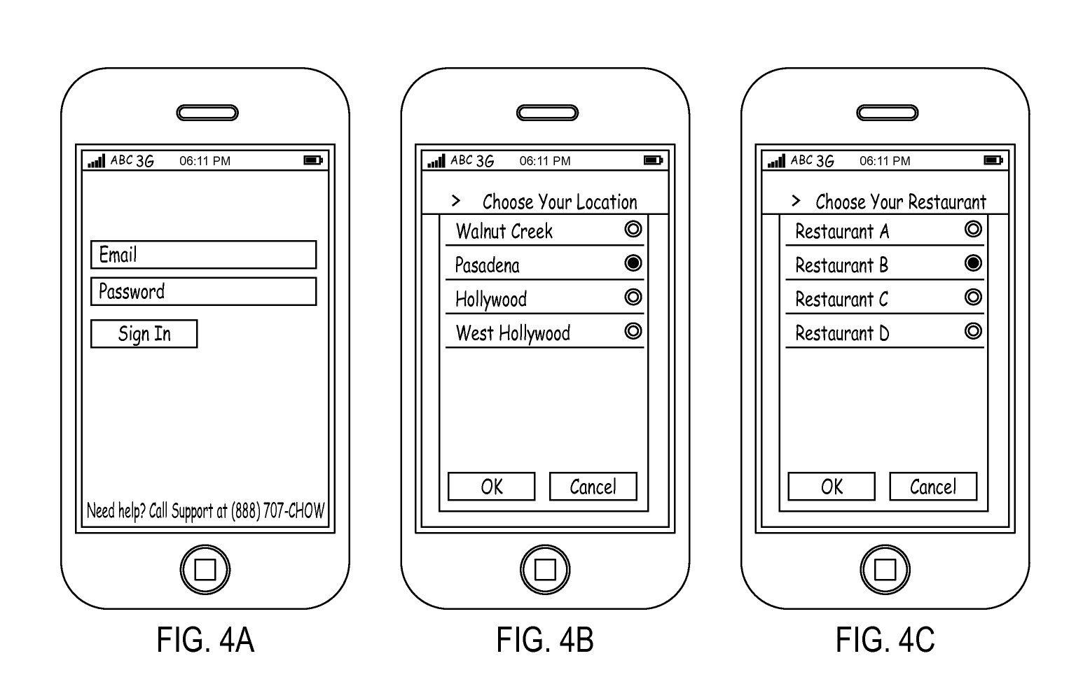

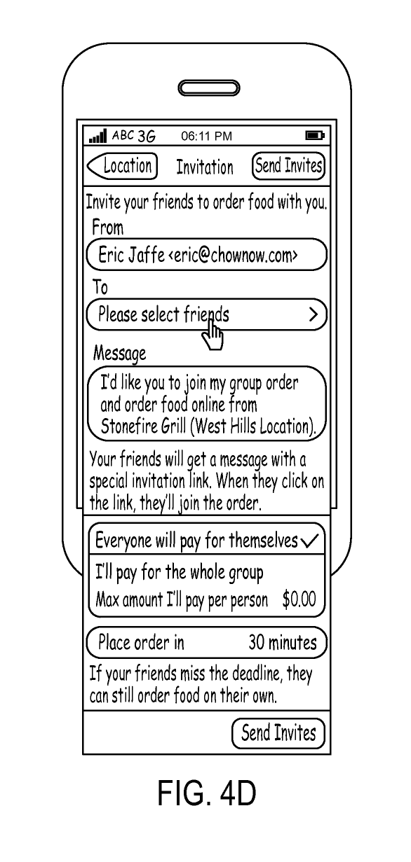

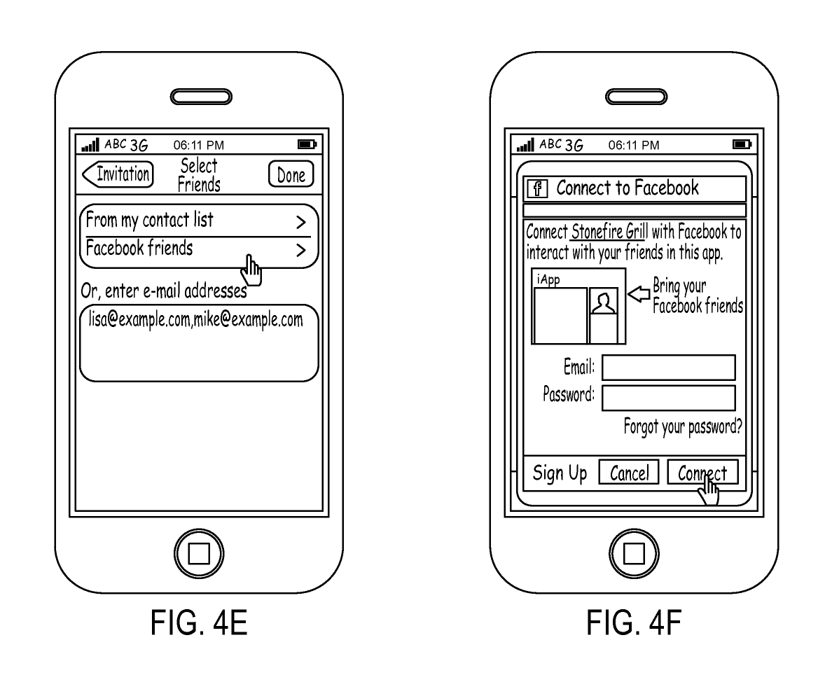

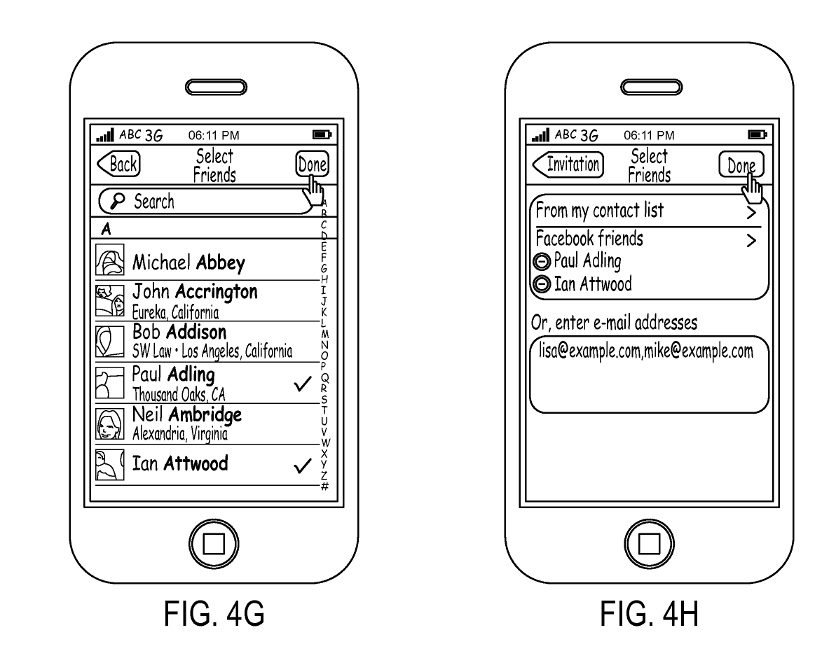

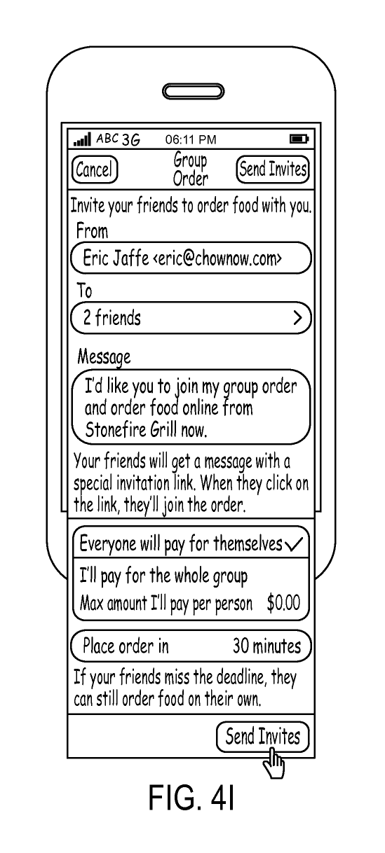

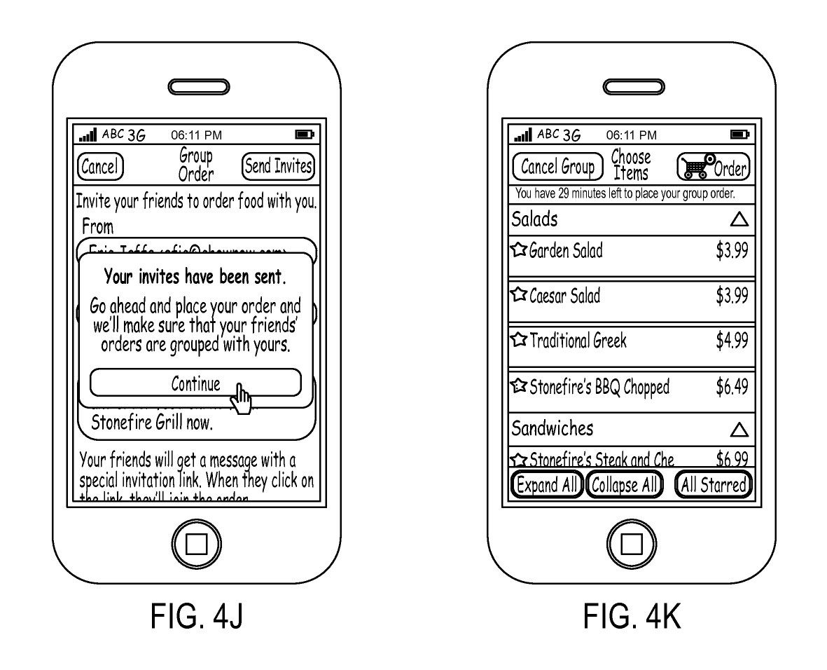

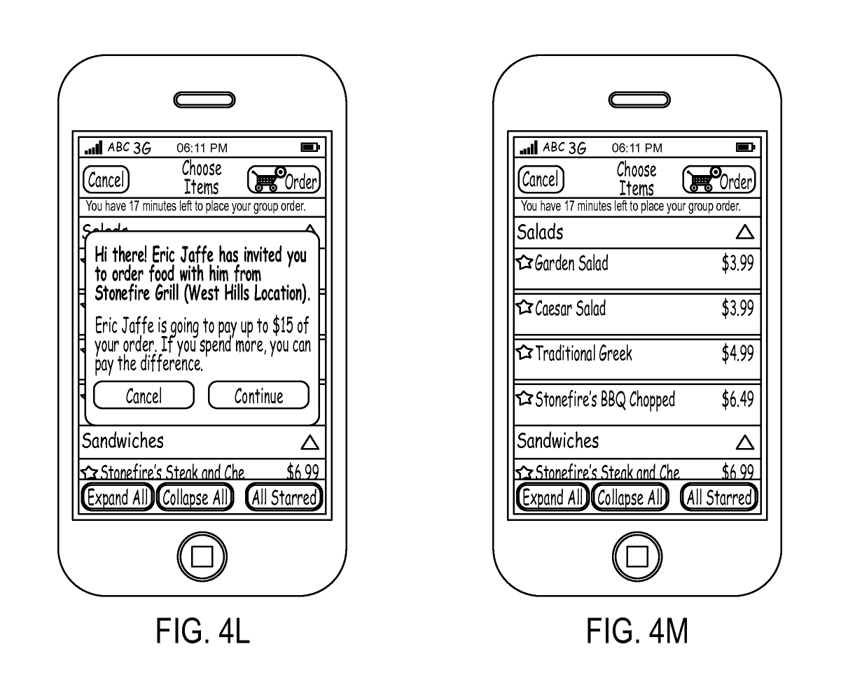

FIGS. 4A-4M illustrate screen shots of a process as disclosed in FIG. 2 for ordering food as a group utilizing an exemplary food ordering application according to exemplary embodiments. When an organizer of, for example a study group opens the exemplary food ordering application on at least one of the plurality of mobile devices 116, 118, 120, the organizer is required to sign in to the exemplary food ordering application by entering an E-mail address and a password as shown in FIG. 4A. In a typical embodiment, the plurality of mobile devices 116, 118, 120 may be, for example, personal digital assistants (PDA), Internet and multimedia-enabled Smartphones, tablet computers, media players, portable computers, and the like. Next, the organizer is provided a pull-down menu showing a plurality of locations available to the organizer The organizer scrolls through the available locations and selects a location as shown in FIG. 4B. Once a location is selected by the organizer, the organizer is provided a pull-down menu as illustrated in FIG. 4C showing a plurality of restaurants, in a vicinity of the previously selected location, from which food can be ordered.

Next, as shown in FIGS. 4D-4I, the organizer invites other individuals in, for example, the study group to join a meal order. For example, the invitations may be extended to other individuals by entering their E-mail addresses. In alternate embodiments, the invitations may be extended to other individuals via social networking sites such as, for example, Facebook®. FIG. 4J illustrates a notification on the organizer's mobile device that the invitations have been extended to other individuals in, for example, the study group. Next, the exemplary food ordering application displays a menu of the selected restaurants on the mobile device of the organizer as shown in FIG. 4K. FIG. 4L illustrates an invitation notification received by the other individuals of the study group on their mobile devices. Next, as shown in FIG. 4M, the other individuals in the study group see the menu of the selected restaurants on their mobile device.

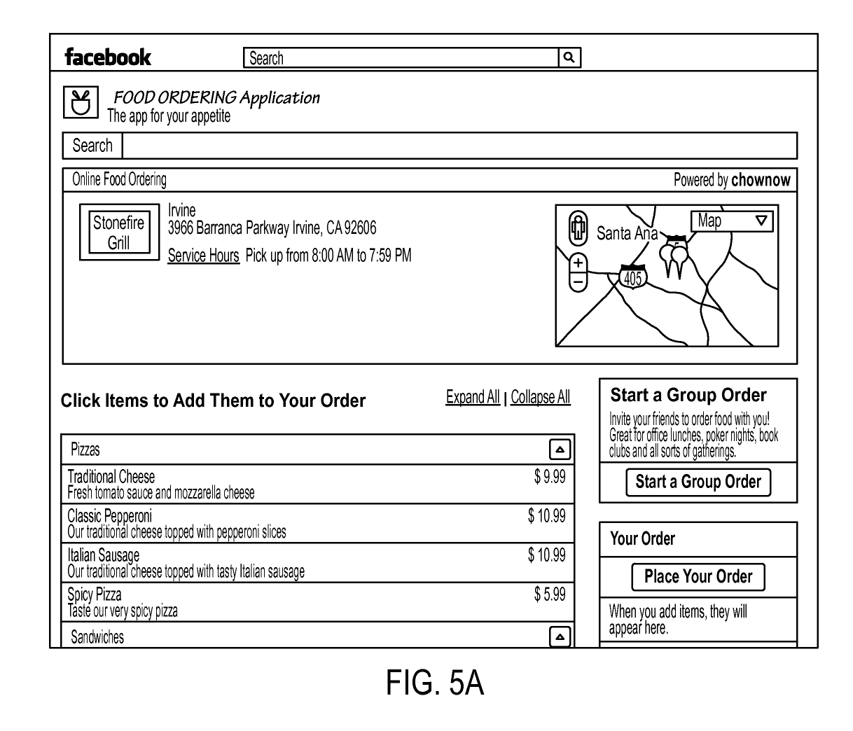

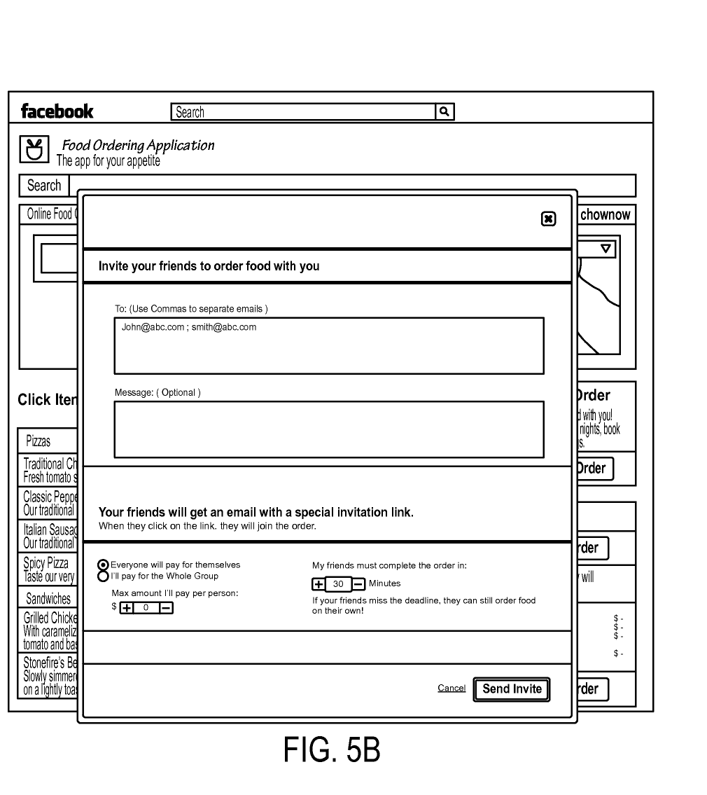

FIGS. 5A-5B illustrate screen shots of the exemplary food ordering application utilizing social networking sites such as, for example, Facebook®. For example, the exemplary food ordering application comprises a group food ordering feature that allows a plurality of individuals such as, for example, friends and co-workers to place food orders together from different locations utilizing social networking sites such as, for example, Facebook®. The exemplary food ordering application further provides an ability to pay separately despite the restaurant receiving the food order as one single consolidated order.

Embodiments of the present invention require a use of an exemplary food ordering application for ordering meals as a group using, for example, mobile devices or social networking sites such as, for example, Facebook®. The exemplary food ordering application enables an individual who may be, for example, an organizer to schedule a food order by choosing a restaurant and delivery time. Next, the organizer invites other individuals to join the food order. The exemplary food ordering application allows each individual to order items they prefer without needing to relay their choice through the organizer. The exemplary food ordering application allows for group food ordering in a time-efficient manner and eliminates errors due to manual ordering. Since the exemplary food ordering application provides an ability for each individual to pay separately despite the restaurant receiving the food order as one single consolidated order, fair billing is achieved and billing reconciliation issues are avoided. In a typical embodiment, the exemplary food ordering application comprises a group food ordering feature that allows a plurality of individuals such as, for example, friends and co-workers to place food orders together from different locations. The exemplary food ordering application further provides an ability to pay separately despite the restaurant receiving the food order as one single consolidated order.

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

It is thus believed that the operation and construction of embodiments of the present invention will be apparent from the foregoing description. While the method and system shown or described have been characterized as being preferred it will be obvious that various changes and modifications may be made therein without departing from the spirit and scope of the invention.

What is claimed is:

1. A method of ordering food using mobile devices, the method comprising:
initiating, by an organizer, a food ordering application on at least one mobile device of a plurality of mobile devices;
selecting, by the organizer, a restaurant for ordering the food;
creating, by the organizer, a single group meal order by inviting a plurality of individuals to order food from the selected restaurant;
accepting, by the plurality of individuals, the invitation;
reviewing, by the organizer and the plurality of individuals on the plurality of mobile devices, a menu of the selected restaurant;
selecting, by the organizer and the plurality of individuals, a plurality of food items from the menu;
combining, by the food ordering application, the plurality of selected food items into the single group meal order; and
forwarding, by the food ordering application, the single group meal order to the selected restaurant.

2. The method of claim 1, comprising receiving, by the organizer and the plurality of individuals on the plurality of mobile devices, a notification after the single group meal order is received by the selected restaurant.

3. The method of claim 1, comprising billing, each one of the plurality of individuals separately for the selected food items.

4. The method of claim 1, comprising sending, via the food ordering application, a single payment to the restaurant for the single group meal order.

5. The method of claim 1, wherein the food ordering application facilitates a purchase transaction between the plurality of mobile devices and the selected restaurant.

6. The method of claim 1, wherein the plurality of mobile devices interact with a plurality of servers to request a plurality of data items stored in a plurality of databases.

7. The method of claim 6, wherein the plurality of data items comprise the menu for the selected restaurant.

8. The method of claim 6, wherein the plurality of servers are connected to the plurality of mobile devices via a network.

9. The method of claim 8, wherein the network comprises at least one of cellular networks, Wi-Fi networks, and WiMAX networks.

10. The method of claim 1, wherein the food ordering application comprises a third-party computer software application operable to be downloaded on the plurality of mobile devices.

11. The method of claim 1, wherein the plurality of mobile devices comprise at least one of personal digital assistants (PDA), Internet and multimedia-enabled Smartphones, tablet computers, portable media players and portable computers.

12. The method of claim 1, wherein the organizer and the plurality of individuals select the plurality of food items from a plurality of locations.

13. The method of claim 1, wherein the food ordering application comprises a third-party computer software application for social networking sites.

14. The method of claim 1, wherein the food ordering application operates on the plurality of mobile devices.

15. The method of claim 1, comprising dropping, at least one individual, from the single group meal order if said at least one individual fails to at least one of accept or decline the invitation.

16. The method of claim 1, comprising collecting, by the food ordering application, payments from each one of the plurality of individuals separately.

17. A computer-program product comprising a computer-usable medium having computer-readable program code embodied therein, the computer-readable program code adapted to be executed to implement a method using mobile devices comprising:
initiating, by an organizer, a food ordering application on at least one mobile device of a plurality of mobile devices;
selecting, by the organizer, a restaurant for ordering the food;
creating, by the organizer, a single group meal order by inviting a plurality of individuals to order food from the selected restaurant;
accepting, by the plurality of individuals, the invitation;
reviewing, by the organizer and the plurality of individuals on the plurality of mobile devices, a menu of the selected restaurant;
selecting, by the organizer and the plurality of individuals, a plurality of food items from the menu;
combining, by the food ordering application, the plurality of selected food items into the single group meal order; and
forwarding, by the food ordering application, the single group meal order to the selected restaurant.

18. The computer-program product of claim 17, wherein the food ordering application facilitates a purchase transaction between the plurality of mobile devices and the selected restaurant.

19. The computer-program product of claim 17, wherein the food ordering application comprises a third-party computer software application operable to be downloaded on the plurality of mobile devices.

20. A system for ordering food, the system comprising:
a plurality of mobile devices that operate a food ordering application;
a plurality of servers coupled to the plurality of mobile devices via a network;
wherein an organizer initiates the food ordering application on at least one of the plurality of mobile devices, selects a restaurant for ordering the food, and creates a single group meal order by inviting a plurality of individuals to order food from the selected restaurant;
wherein the plurality of individuals accept the invitation using the plurality of mobile devices;
wherein the organizer and the plurality of individuals select a plurality of food items from a menu displayed on the plurality of mobile devices; and
wherein the food ordering application combines the plurality of selected food items into the single group meal order and forwards the single group meal order to the selected restaurant.
